(19) United States
(12) Patent Application Publication
(10) Pub. No.: US 2026/0222722 A1
(43) Pub. Date: Jul. 30, 2026

(54) EARPHONE WEARING STATE DETECTION METHOD AND APPARATUS, AND EARPHONE AND STORAGE MEDIUM

(71) Applicant: SHENZHEN TONLY SCIENCE AND TECHNOLOGY DEVELOPMENT CO., LTD., Shenzhen, Guangdong (CN)

(72) Inventors: Liechao HUANG, Shenzhen, Guangdong (CN); Yucheng ZHAO, Shenzhen, Guangdong (CN); Guanghui HAN, Shenzhen, Guangdong (CN); Jinhui LI, Shenzhen, Guangdong (CN); Hua YAN, Shenzhen, Guangdong (CN); Xinwen CHEN, Shenzhen, Guangdong (CN)

(73) Assignee: SHENZHEN TONLY SCIENCE AND TECHNOLOGY DEVELOPMENT CO., LTD., Shenzhen, Guangdong (CN)

(21) Appl. No.: 19/147,687

(22) PCT Filed: Nov. 21, 2023
(86) PCT No.: PCT/CN2023/132852

§ 371 Date: Jul. 11, 2025

(30) Foreign Application Priority Data
Nov. 9, 2023 (CN) 202311493500.9

(51) Int. Cl. H04R 1/10; H04R 3/00; H04R 29/00

(52) U.S. Cl. CPC H04R 1/1041; H04R 29/001; H04R 3/00; H04R 2460/15

(57) ABSTRACT

An earphone wearing state detection method includes acquiring a detection request for a wearing state of an earphone, performing audio collection through a feedback microphone of the earphone to obtain a feedback audio signal, determining a frequency of an audio and based on the frequency, determining a target frequency band in the feedback audio signal in which a frequency range meets a preset condition, determining a power spectrum of the feedback audio signal, based on a power spectrum, determining an energy magnitude indicator value of the feedback audio signal within a range of the target frequency band, and if the energy magnitude indicator value is not lower than a preset minimum energy threshold corresponding to an in-ear state, determining that the wearing state of the earphone is the in-ear state.

### TECHNICAL FIELD

The present application relates to the field of terminal control technologies, and specifically to an earphone wearing state detection method and apparatus, and earphone and storage medium.

### BACKGROUND TECHNOLOGY

In recent years, true wireless stereo (TWS) earphone market has been rapidly growing. Due to their compact size, portability, and user convenience, TWS earphones have become popular among consumers. Currently, mid to high-end TWS earphones support in-ear detection functionality, enabling automatic music playback when worn and automatic pause when removed, thereby making the earphones more intelligent and power-efficient.

The mainstream in-ear detection solutions for TWS earphones currently include capacitive sensor-based solutions and optical sensor-based solutions. The capacitive solution detects whether the earphone is in-ear by sensing a capacitance value of a human body. Its advantages include lower cost and no need for openings in an earphone housing, resulting in a more aesthetically pleasing design; however, it has a relatively high false trigger rate. The optical detection solution determines the in-ear state by using infrared light emission, reflection, and resulting signal levels. Compared to the capacitive solution, the optical solution offers higher accuracy, but it comes with higher cost, potential false triggers in certain scenarios, and stricter requirements for manufacturing and assembly processes.

However, both of the above solutions are prone to mistakenly identifying the earphones as being in the in-ear state. For example, in common scenarios such as placing the earphones on a table, holding them in hand, or putting them in a pocket, optical or capacitive sensors can easily produce false positives, incorrectly determining that the earphones are being worn. This leads to inaccurate in-ear detection, negatively impacting user experience and increasing power consumption.

### SUMMARY OF INVENTION

The embodiments of the present application provide an earphone wearing state detection method and apparatus, and earphone and storage medium, which can improve accuracy of detecting a wearing state of the earphone.

In a first aspect, an embodiment of the present application provides an earphone wearing state detection method, comprising:
acquiring a detection request for a wearing state of an earphone.
performing audio collection through a feedback microphone of the earphone to obtain a feedback audio signal.
determining a frequency of an audio and based on the frequency, determining a target frequency band in the feedback audio signal in which a frequency range meets a preset condition.
determining a power spectrum of the feedback audio signal.
based on a power spectrum, determining an energy magnitude indicator value of the feedback audio signal within a range of the target frequency band.
if the energy magnitude indicator value is not lower than a preset minimum energy threshold corresponding to an in-ear state, determining that the wearing state of the earphone is the in-ear state.

In a second aspect, an embodiment of the present application further provides an earphone wearing state detection apparatus, comprising:
a detection request acquisitor configured to acquire a detection request for a wearing state of an earphone.
a feedback audio signal determiner configured to perform audio collection through a feedback microphone of the earphone to obtain a feedback audio signal.
a target frequency band determiner configured to determine a frequency of an audio and based on the frequency, determine a target frequency band in the feedback audio signal in which the frequency range meets a preset condition.
a power spectrum determiner configured to determine a power spectrum of the feedback audio signal.
an energy magnitude indicator value determiner configured to determine, based on the power spectrum, an energy magnitude indicator value of the feedback audio signal within the range of the target frequency band.
a wearing state determiner configured to determine that the wearing state of the earphone is an in-ear state if the energy magnitude indicator value is not lower than a preset minimum energy threshold corresponding to the in-ear state.

In a third aspect, an embodiment of the present application further provides an earphone, comprising a memory storing a plurality of instructions; the processor is configured to load the instructions from the memory to execute steps of any of the earphone wearing state detection methods provided in the embodiments of the present application.

In a fourth aspect, an embodiment of the present application further provides a computer-readable storage medium, wherein the computer-readable storage medium stores a plurality of instructions, which are configured to be loaded by a processor to execute steps of any of the earphone wearing state detection methods provided in the embodiments of the present application.

In a fifth aspect, an embodiment of the present application further provides a computer program product, comprising a computer program or instructions, which, when executed by a processor, implement steps of any of the earphone wearing state detection methods provided in the embodiments of the present application.

By adopting the solution of the present application embodiment, a detection request for the wearing state of the earphone can be acquired; audio collection is performed through a feedback microphone of the earphone to obtain a feedback audio signal; the frequency of the audio is determined, and based on the frequency, a target frequency band in the feedback audio signal is determined, wherein the frequency range meets a preset condition; a power spectrum of the feedback audio signal is determined; based on the power spectrum, an energy magnitude indicator value of the feedback audio signal within the range of the target frequency band is determined; if the energy magnitude indicator value is not lower than a preset minimum energy threshold corresponding to the in-ear state, the wearing state of the earphone is determined to be the in-ear state.

### BRIEF DESCRIPTION OF THE DRAWINGS

To more clearly illustrate the technical solutions in the embodiments of the present application, a brief description of the drawings used in the embodiments is provided below. It is obvious that the drawings described below are merely some embodiments of the present application. Those skilled in the art may obtain other drawings based on these drawings without creative effort.

FIG. 1 is a schematic flow diagram of one embodiment of an earphone wearing state detection method provided in the present application.

FIG. 2 is a structural schematic diagram of an earphone wearing state detection apparatus provided in the present application.

FIG. 3 is a structural schematic diagram of an earphone provided in the present application.

### DETAILED DESCRIPTION OF THE EMBODIMENTS

The following provides a clear and complete description of the technical solutions in the embodiments of the present application with reference to the accompanying drawings. It is evident that the described embodiments are only part of the embodiments of the present application, rather than all of them. Based on the embodiments in the present application, all other embodiments that can be obtained by those skilled in the art without creative effort shall fall within the scope of protection of the present application. Meanwhile, in the description of the embodiments of the present application, the terms “first,” “second,” and the like are used solely for the purpose of distinguishing one feature from another and should not be construed as indicating or implying relative importance. Therefore, features labeled with “first,” “second,” etc., may include one or more such features, either explicitly or implicitly. In the description of the embodiments of the present application, the term “plurality” means two or more, unless otherwise specifically defined.

The embodiments of the present application provide an earphone wearing state detection method and apparatus, and earphone and storage medium.

Specifically, this embodiment is described from the perspective of an earphone wearing state detection apparatus, which may be integrated into the earphone. That is, the earphone wearing state detection method of the present application embodiment can be executed by the earphone. Optionally, the earphone may be a terminal device with data processing capabilities. The terminal device refers to the earphone, and the type of the earphone is not limited, including but not limited to wired earphones, wireless earphones, Bluetooth earphones, and over-ear headphones. The earphone may exist independently or as an accessory device on another device, such as a head-mounted display device. This embodiment imposes no limitations in this regard.

By way of example, the earphone wearing state detection apparatus may be specifically integrated into a true wireless stereo (TWS) earphone. A TWS earphone refers to an earphone without traditional connecting wires, including Bluetooth earphones, infrared earphones, and the like. TWS earphones support in-ear detection functionality. In-ear detection, also known as wearing detection, is applied to TWS earphones to achieve the primary function of determining whether the user is wearing or has removed the earphone. Currently, the main detection solutions for TWS earphone wearing state include capacitive sensor-based solutions and optical sensor-based solutions. The earphone wearing state detection method provided in the embodiments of the present application is applicable to capacitive sensor-based solutions, optical sensor-based solutions, or sensor-based solutions derived from a combination or improvement thereof.

The following provides a detailed description with reference to the accompanying drawings. In this embodiment, the executing entity is an earphone capable of invoking a deduplication algorithm. It should be noted that the order of description of the following embodiments is not intended to limit the preferred sequence of implementation. Although a logical order is shown in the flowcharts, in certain cases, the steps shown or described may be performed in an order different from that illustrated in the drawings.

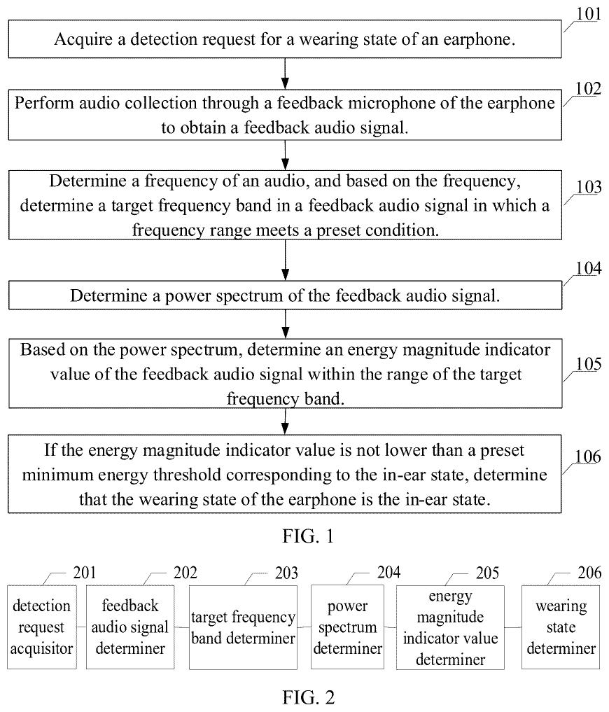

Referring to FIG. 1, the specific process of the earphone wearing state detection method may include steps 101 to 106, wherein:

Step 101: Acquire a detection request for a wearing state of an earphone.

In this embodiment, the above-mentioned detection request for the wearing state of the earphone refers to a request to detect the wearing state of the earphone. The wearing state of the earphone includes, but is not limited to, an in-ear state and an out-of-ear state. The in-ear state refers to a condition in which the earphone is being worn and is located inside the user's ear. This includes both the moment when the earphone has just been inserted into the ear and a sustained state in which the earphone remains inside the ear. The out-of-ear state refers to a condition in which the earphone is not being worn and is located outside the user's ear. For example, when the earphone is placed in a charging case, on a table, in the user's hand, or in the user's pocket, it is considered to be in the out-of-ear state.

In this embodiment, the earphone refers to the one for which the wearing state detection is to be performed, such as an active noise-canceling earphone, or one of the earphones in a pair of TWS earphones. Specifically, if the earphone is one of a pair of TWS earphones, its wireless connection to the other earphone or to a smart device may be established via at least one of the following communication methods: Wi-Fi communication, classic Bluetooth communication, BLE communication, LE Audio, ANT communication, RF4CE communication, Zigbee communication, NFC communication, or UWB communication.

Optionally, the detection request for the wearing state of the earphone may be triggered based on actual conditions.

For example, acquiring the detection request for the wearing state of the earphone may specifically include:
periodically generating the detection request for the wearing state of the earphone.
or generating the detection request for the wearing state of the earphone when a sensor of the earphone detects that the wearing state has switched to an in-ear state.

In this example, a timer is used to periodically generate the detection request for the wearing state of the earphone at a trigger time of a timer. The interval for generating the detection request using the timer can be adjusted based on actual requirements. For instance, if the timer trigger interval is set to 1.5 seconds, the detection request for the wearing state of the earphone is generated every 1.5 seconds. By reasonably generating the detection request at timed intervals, the system can respond quickly to the detection request for the wearing state of the earphone, thereby improving the responsiveness of the detection process and enhancing the overall user experience.

In this example, based on the type of earphone sensor, the earphone collects signals related to that sensor type through the corresponding sensor. The wearing state of the earphone is determined based on the collected signals to identify whether a change has occurred. For instance, if the earphone sensor is a capacitive sensor, the earphone collects capacitance values through the capacitive sensor, and changes in the capacitance values are used to determine whether the wearing state has changed. Similarly, if the earphone sensor is an optical sensor, the earphone collects level signals through the optical sensor, and changes in the level signals are used to determine whether the wearing state has changed. When the sensor determines, based on the collected signal, that the earphone's wearing state has switched to the in-ear state, a detection request for the wearing state of the earphone is generated. The determination of a switch to the in-ear state includes, for example, a transition from the out-of-ear state to the in-ear state, or from another state to the in-ear state. If the sensor determines, based on the collected signal, that the wearing state has switched to the out-of-ear state, or that the earphone remains in a sustained out-of-ear state, or a sustained in-ear state, then the sensor continues to collect signals. A sustained out-of-ear state refers to the earphone remaining in the out-of-ear state for a duration exceeding a preset threshold. A sustained in-ear state refers to the earphone remaining in the in-ear state for a duration exceeding a preset threshold. The preset duration is configured based on actual requirements, for example, 200 milliseconds.

Step 102: Perform audio collection through a feedback microphone of the earphone to obtain a feedback audio signal.

In this embodiment, the above-mentioned feedback microphone may be positioned at the front end of the earphone's speaker and is used to collect audio signals from the current environment. The audio may include, but is not limited to, prompt tones, the friction sound generated when the earphone is inserted into the ear canal, and ambient environmental sounds. The prompt tone may be played by the earphone and has a preset frequency.

In this embodiment, when the audio includes a prompt tone, the feedback microphone of the earphone collects the prompt tone to obtain a feedback audio signal. When the audio includes ambient environmental sound, the feedback microphone collects the ambient sound to obtain a feedback audio signal. Specifically, the audio settings can be configured according to actual requirements.

It is understood that when the audio includes the friction sound between the earphone and the ear canal during insertion, as well as ambient environmental sound, the actual scene of the earphone can be used to determine the context. For example, when the actual wearing state of the earphone is the in-ear state, the audio collected by the feedback microphone primarily includes the friction sound generated as the earphone enters the ear canal. When the actual wearing state is the out-of-ear state, the audio collected by the feedback microphone primarily includes ambient environmental sound.

In this embodiment, when the audio is a prompt tone, the prompt tone is used to perform detection of the earphone's wearing state. The frequency of the prompt tone includes, but is not limited to, ultrasound, infrasound, and audible sound waves. Ultrasound refers to sound waves with frequencies above 20,000 Hz, infrasound refers to sound waves with frequencies below 20 Hz, and audible sound waves refer to sound waves within the frequency range of 20 Hz to 20,000 Hz that can be heard by the human ear. When the frequency of the prompt tone falls within the audible range, it can be configured according to actual needs, for example, a prompt tone consisting of two “ding” sounds, or a spoken prompt such as “Activating in-ear detection function.” The frequency of the prompt tone can be specifically set as needed, such as a prompt tone at 20 Hz or at 10 Hz. Preferably, infrasound is used as the prompt tone.

It is understood that when infrasound is played through the earphone's internal speaker, the amplitude of the infrasound collected by the feedback microphone differs significantly depending on whether the earphone is in the ear or not. When the earphone is in the ear, the amplitude of the infrasound collected by the feedback microphone increases significantly. By using infrasound as the prompt tone to perform wearing state detection, the detection results become more accurate.

In this embodiment, the audio collection may be configured with preset parameters, which include but are not limited to the signal length and sampling rate of the audio signal. The signal length refers to the duration of the collected audio signal, for example, a signal length ranging from 0.5 seconds to 1.2 seconds. The sampling rate refers to the number of samples taken from the audio signal per unit of time; for instance, a sampling rate of 16k means 16,000 samples are taken per second.

Step 103: Determine a frequency of an audio, and based on the frequency, determine a target frequency band in a feedback audio signal in which a frequency range meets a preset condition.

In this embodiment, based on the frequency range of the frequency band signal to be analyzed, an appropriate filter is used to extract the target frequency band signal from the audio. The frequency corresponding to the frequency band signal is regarded as the frequency of the audio. The frequency range of the frequency band signal to be analyzed is related to the type of filter used. For example, when the frequency band signal to be analyzed is a low-frequency signal, the filter used is a low-pass filter.

In this embodiment, the target frequency band refers to the frequency range within the feedback audio signal that meets a preset condition and is used for detecting the wearing state of the earphone. When the audio is a prompt tone with a preset frequency, the condition that the frequency range meets the preset requirement means that the target frequency band includes the frequency at which the prompt tone is played. The preset condition can be adjusted according to actual needs. For example, the starting point of the frequency range of the target frequency band may be the frequency of the prompt tone; alternatively, the center frequency of the target frequency band may be the frequency of the prompt tone.

Optionally, if the preset condition is that the center frequency of the target frequency band is the frequency of the audio, then determining the target frequency band in the feedback audio signal, in which the frequency range meets the preset condition based on the frequency, comprises:
acquiring the frequency band length of the target frequency band to be determined.
based on the frequency band length and using the frequency as the center, determining the target frequency band from the feedback audio signal.

In this example, the frequency band length refers to the span from the starting frequency to the ending frequency within the target frequency band. For instance, if the frequency range of the target frequency band is (10 Hz, 30 Hz), then the frequency band length is 20 units.

In this example, if the preset condition is that the center frequency of the target frequency band is the frequency of the audio, then the target frequency band is determined from the feedback audio signal using the frequency as the center frequency, with a length equal to the frequency band length.

By way of example, assuming the frequency is 40 Hz and the frequency band length is 20 units, the target frequency band (30 Hz, 50 Hz) is determined from the feedback audio signal using 40 Hz as the center frequency and with a length equal to the frequency band length. Optionally, if the preset condition is that the frequency range of the target frequency band contains the frequency of the audio, then determining the target frequency band in the feedback audio signal based on the frequency comprises:
acquiring the frequency band length of the target frequency band to be determined.
based on the frequency and the frequency band length, determining a target frequency band that contains the frequency and has a length equal to the frequency band length.

In this example, the frequency band length refers to the span from the starting frequency to the ending frequency within the target frequency band. For example, if the frequency range of the target frequency band is (10 Hz, 30 Hz), then the frequency band length is 20 units.

In this example, if the preset condition is that the frequency range of the target frequency band contains the frequency of the audio, then the frequency and the frequency band length are used to determine a target frequency band that contains the frequency and has a length equal to the frequency band length.

By way of example, assuming the frequency is 40 Hz and the frequency band length is 20 units, a target frequency band is determined from the feedback audio signal that has a length of 20 units and contains the frequency of 40 Hz.

In this embodiment, by determining a target frequency band in the feedback audio signal in which the frequency range meets a preset condition and analyzing this target frequency band, the accuracy of detecting the wearing state of the earphone can be improved.

Step 104: Determine a power spectrum of the feedback audio signal.

In this embodiment, the power spectrum refers to the power spectral density function, which is defined as the signal power within a unit frequency band. It represents how the signal power varies with frequency, that is, the distribution of signal power in the frequency domain. The power spectrum reflects the relationship between signal power and frequency.

In this embodiment, the power spectrum of the feedback audio signal can be determined by first performing frame division and windowing on the feedback audio signal, and then applying a Fourier transform to the windowed signal to obtain a frequency-domain signal. The magnitude of the frequency-domain signal is taken to determine the energy spectrum of the feedback audio signal, and the power spectrum is then derived from the energy spectrum. The frequency domain is a coordinate system used to describe the characteristics of a signal in terms of frequency. The energy spectrum, also known as the energy spectral density, describes how the energy of a signal or time series is distributed across different frequencies. The energy spectrum is the square of the Fourier transform of the original signal.

In this embodiment, the power spectrum of the feedback audio signal can also be determined by performing filtering based on the frequency of the audio. The filtered feedback audio signal is then used to obtain the power spectrum. The power values corresponding to the same frequency components in the power spectrum are averaged to obtain the average power spectrum of the feedback audio signal. This average power spectrum is composed of audio signals at different frequencies.

Step 105: Based on the power spectrum, determine an energy magnitude indicator value of the feedback audio signal within the range of the target frequency band.

In this embodiment, the energy magnitude indicator value is a metric used to characterize the amount of energy of the feedback audio signal within the range of the target frequency band. This energy magnitude indicator value is the root mean square value, which represents the magnitude of energy in a signal. By extracting parameters from the power spectrum and performing energy magnitude calculations on those parameters, the energy magnitude indicator value is obtained. The parameters in the power spectrum refer to the power corresponding to each frequency in the feedback audio signal.

Further, determining the energy magnitude indicator value of the feedback audio signal within the range of the target frequency band based on the power spectrum comprises:
determining the power of the feedback audio signal within the range of the target frequency band based on the power spectrum.
performing a root mean square calculation on the power within the target frequency band to determine the energy magnitude indicator value.

In this embodiment, determining the power of the feedback audio signal within the target frequency band includes the power corresponding to multiple frequencies. The root mean square calculation refers to the process of squaring the power at each frequency within the target frequency band, summing the squared values, dividing the result by the total number of frequencies, and then taking the square root. The total number of frequencies refers to the number of frequencies within the target frequency band.

In this embodiment, by determining the energy magnitude indicator value of the feedback audio signal within the range of the target frequency band and comparing the energy magnitude indicator value with the energy threshold values corresponding to the power spectra of different wearing states of the earphone, the wearing state of the earphone can be accurately identified, thereby improving the accuracy of earphone wearing state detection.

Step 106: If the energy magnitude indicator value is not lower than a preset minimum energy threshold corresponding to the in-ear state, determine that the wearing state of the earphone is the in-ear state.

In this embodiment, the preset minimum energy threshold is used to characterize the minimum energy value in the power spectrum of the audio when collected by the feedback microphone under the in-ear state. That is, when the energy magnitude indicator value is not lower than the preset minimum energy threshold corresponding to the in-ear state, the wearing state of the earphone can be determined to be the in-ear state.

It is understood that the preset minimum energy threshold can be obtained in advance through experimental measurements. The purpose of setting this preset minimum energy threshold is to identify whether the wearing state of the earphone is the in-ear state by comparing the energy magnitude indicator value with the preset minimum energy threshold. When the earphone switches to the in-ear state, the comparison between the energy magnitude indicator value and the preset minimum energy threshold helps determine whether the earphone is indeed in the in-ear state, thereby improving the accuracy of earphone wearing state detection.

When performing audio collection through the feedback microphone of the earphone, the audio is further collected through a feedforward microphone of the earphone to obtain a feedforward audio signal.

The method further comprises:
performing sound pressure level analysis on the feedforward audio signal and the feedback audio signal to determine a first sound pressure level of the feedforward audio signal and a second sound pressure level of the feedback audio signal.
determining a sound pressure level difference between the first sound pressure level and the second sound pressure level.
if the sound pressure level difference is not less than a maximum sound pressure level difference threshold, determining that the wearing state of the earphone is the in-ear state;

otherwise, determining that the wearing state of the earphone is an out-of-ear state.

In this embodiment, the feedforward microphone may be positioned on the outer side of the earphone housing, closer to the outside of the ear, and is used to collect audio signals from the external environment. For example, when the actual wearing state of the earphone is the in-ear state, the audio collected by the feedforward microphone primarily consists of the friction sound generated between the earphone and the ear canal. When the actual wearing state of the earphone is the out-of-ear state, the feedforward microphone collects ambient environmental sound.

In this embodiment, the sound pressure level analysis refers to the process of analyzing the sound pressure levels of the feedforward audio signal collected by the feedforward microphone and the feedback audio signal collected by the feedback microphone. Sound pressure level is used to characterize the sound energy level of the collected audio signals. The first sound pressure level refers to the sound pressure level of the feedforward audio signal after performing sound pressure level analysis on the signal collected by the feedforward microphone. The second sound pressure level refers to the sound pressure level of the feedback audio signal after performing sound pressure level analysis on the signal collected by the feedback microphone.

In this embodiment, the sound pressure level difference may refer to either the direct difference between the two sound pressure level values or the difference between their absolute values. The method for calculating the sound pressure level difference can be adjusted based on actual requirements. Preferably, the present application adopts the approach of calculating the difference between the absolute values of the first sound pressure level and the second sound pressure level to determine the sound pressure level difference. By calculating the difference between the absolute values of the first sound pressure level (from the feedforward microphone) and the second sound pressure level (from the feedback microphone), a more accurate measurement of the energy difference between the two audio signals is obtained. Comparing this energy difference with a maximum sound pressure level difference threshold improves the accuracy of detecting the earphone's wearing state.

In this embodiment, the maximum sound pressure level difference threshold is used to characterize the maximum sound pressure level difference between the second sound pressure level corresponding to the audio signal collected by the feedback microphone and the first sound pressure level corresponding to the audio signal collected by the feedforward microphone under the out-of-ear state. That is, when the sound pressure level difference is not less than the maximum sound pressure level difference threshold, the wearing state of the earphone can be determined to be the in-ear state.

It is understood that the maximum sound pressure level difference threshold can be obtained in advance through experimental measurements. The purpose of setting this threshold is to determine whether the earphone is in the in-ear state by comparing the sound pressure level difference with the maximum sound pressure level difference threshold. When the earphone switches to the in-ear state, this comparison helps confirm whether the earphone is indeed in the in-ear state, thereby improving the accuracy of earphone wearing state detection.

Optionally, performing sound pressure level analysis on the feedforward audio signal and the feedback audio signal comprises:
if the energy magnitude indicator value is lower than the preset minimum energy threshold, performing sound pressure level analysis on the feedforward audio signal and the feedback audio signal.

In this example, by comparing the energy magnitude indicator value with the preset minimum energy threshold, if the indicator value is lower than the threshold, it indicates that the current wearing state of the earphone cannot be clearly determined. In such cases, sound pressure level analysis is performed on both the feedforward audio signal and the feedback audio signal. By analyzing the sound pressure levels of the signals collected by the feedforward and feedback microphones, the sound pressure level difference between them can be determined. Based on this sound pressure level difference, the wearing state of the earphone can be further identified. By combining power spectrum analysis with sound pressure level analysis, the accuracy of earphone wearing state detection is improved.

Optionally, determining the first sound pressure level of the feedforward audio signal and the second sound pressure level of the feedback audio signal comprises:
performing spectrum analysis on the feedforward audio signal and the feedback audio signal to determine a first spectrum of the feedforward audio signal and a second spectrum of the feedback audio signal.
correcting a spectrum parameter of the first spectrum and a spectrum parameter of the second spectrum.
determining the first sound pressure level of the feedforward audio signal and the second sound pressure level of the feedback audio signal based on a corrected first spectrum and a corrected second spectrum.

In this embodiment, spectrum analysis refers to the process of performing a Fourier transform on the feedforward audio signal collected by the feedforward microphone and the feedback audio signal collected by the feedback microphone, followed by analysis of the transformed signals. The spectrum includes both the amplitude spectrum and the phase spectrum. The amplitude spectrum is composed of the amplitude values at each frequency point, while the phase spectrum is composed of the phase values at each frequency point. The first spectrum is used to represent the frequency distribution of the feedforward audio signal after the Fourier transform, and the second spectrum is used to represent the frequency distribution of the feedback audio signal after the Fourier transform.

In this embodiment, the spectrum parameters are related to the type of spectrum. When the spectrum is an amplitude spectrum, the spectrum parameters are the amplitude values at each frequency point; when the spectrum is a phase spectrum, the spectrum parameters are the phase values at each frequency point. The specific configuration can be adjusted according to actual conditions. The correction methods include, but are not limited to, A-weighting, B-weighting, and C-weighting. Other correction methods may also be used. In the context of the present application, “weighting” refers to modifying the spectrum parameters according to certain rules. A-weighting simulates the frequency response of the human ear to low-intensity sounds below 55 dB sound pressure level; B-weighting simulates the ear's response to medium-intensity sounds between 55 dB sound pressure level and 85 dB sound pressure level; C-weighting simulates the ear's response to high-intensity sounds above 85 dB sound pressure level. The selected correction method is related to the frequency of the audio. When the audio is low-frequency, it is preferable to apply A-weighting for correction.

In this embodiment, by performing spectrum analysis on the feedforward audio signal and the feedback audio signal, and correcting the spectrum parameters of the first spectrum and the second spectrum, the first sound pressure level of the feedforward audio signal and the second sound pressure level of the feedback audio signal are determined based on the corrected first spectrum and corrected second spectrum. By combining power spectrum analysis with sound pressure level analysis, the accuracy of earphone wearing state detection is improved.

This embodiment also provides an earphone wearing state detection apparatus, which can be specifically integrated into the earphone.

For example, as shown in FIG. 2, the earphone wearing state detection apparatus may include:
a detection request acquisitor 201 configured to acquire a detection request for a wearing state of an earphone.
a feedback audio signal determiner 202 configured to perform audio collection through a feedback microphone of the earphone to obtain a feedback audio signal.
a target frequency band determiner 203 configured to determine a frequency of an audio and based on the frequency, determine a target frequency band in the feedback audio signal in which the frequency range meets a preset condition.
a power spectrum determiner 204 configured to determine a power spectrum of the feedback audio signal.
an energy magnitude indicator value determiner 205 configured to determine, based on the power spectrum, an energy magnitude indicator value of the feedback audio signal within the range of the target frequency band.
a wearing state determiner 206 configured to determine that the wearing state of the earphone is an in-ear state if the energy magnitude indicator value is not lower than a preset minimum energy threshold corresponding to the in-ear state.

Optionally, in the apparatus of the present application embodiment, when performing audio collection through the feedback microphone of the earphone, audio is also collected through the feedforward microphone of the earphone to obtain a feedforward audio signal.

The earphone wearing state detection apparatus further comprises:
a sound pressure level analyzer configured to perform sound pressure level analysis on the feedforward audio signal and the feedback audio signal to determine a first sound pressure level of the feedforward audio signal and a second sound pressure level of the feedback audio signal.
a sound pressure level difference determiner configured to determine a sound pressure level difference between the first sound pressure level and the second sound pressure level.
a wearing state determiner configured to determine that the wearing state of the earphone is the in-ear state if the sound pressure level difference is not less than a maximum sound pressure level difference threshold; otherwise, to determine that the wearing state of the earphone is an out-of-ear state.

Optionally, in the apparatus of the present application embodiment, within the sound pressure level analyzer, the sound pressure level analysis of the feedforward audio signal and the feedback audio signal comprises:
if the energy magnitude indicator value is lower than the preset minimum energy threshold, performing sound pressure level analysis on the feedforward audio signal and the feedback audio signal.

Optionally, in the apparatus of the present application embodiment, within the sound pressure level analyzer, determining the first sound pressure level of the feedforward audio signal and the second sound pressure level of the feedback audio signal comprises:
a spectrum analyzer configured to perform spectrum analysis on the feedforward audio signal and the feedback audio signal to determine a first spectrum of the feedforward audio signal and a second spectrum of the feedback audio signal.
a corrector configured to correct the spectrum parameters of the first spectrum and the second spectrum.
a sound pressure level determiner configured to determine the first sound pressure level of the feedforward audio signal and the second sound pressure level of the feedback audio signal based on the corrected first spectrum and the corrected second spectrum.

Optionally, in the apparatus of the present application embodiment, within the target frequency band determiner 203, determining the target frequency band in the feedback audio signal in which the frequency range meets a preset condition based on the frequency comprises:
a frequency band length acquisitor configured to acquire the frequency band length of the target frequency band to be determined.
a target frequency band determiner configured to determine a target frequency band that contains the frequency and has a length equal to the frequency band length, based on the frequency and the frequency band length.

Optionally, in the apparatus of the present application embodiment, within the energy magnitude indicator value determiner 205, determining the energy magnitude indicator value of the feedback audio signal within the range of the target frequency band based on the power spectrum comprises:
a power determiner configured to determine the power of the feedback audio signal within the range of the target frequency band based on the power spectrum.
an energy magnitude indicator value determiner configured to perform a root mean square calculation on the power within the target frequency band to determine the energy magnitude indicator value.

Optionally, in the apparatus of the present application embodiment, within the detection request acquisitor 201, acquiring the detection request for the wearing state of the earphone comprises:
a first generator configured to periodically generate a detection request for the wearing state of the earphone.
or
a second generator configured to generate a detection request for the wearing state of the earphone when a sensor of the earphone detects that the wearing state has switched to the in-ear state.

By adopting the apparatus of this embodiment, the wearing state of the earphone can be determined by comparing the energy magnitude indicator value within the target frequency band range with the preset minimum energy threshold corresponding to the in-ear state, thereby improving the accuracy of detecting the earphone's wearing state.

Accordingly, the present application embodiment also provides an earphone, the type of which is not limited and may include, for example, wired earphones, wireless earphones, Bluetooth earphones, over-ear headphones, and so on.

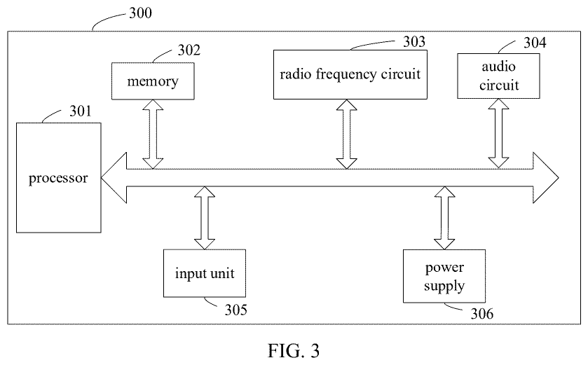

As shown in FIG. 3, FIG. 3 is a structural schematic diagram of an earphone provided in an embodiment of the present application. The earphone 300 includes a processor 301 having one or more processing cores, a memory 302 having one or more computer-readable storage media, and a computer program stored in the memory 302 and executable by the processor. The processor 301 is electrically connected to the memory 302. It should be understood by those skilled in the art that the earphone structure shown in the figure does not limit the earphone and may include more or fewer components than illustrated, or may combine certain components, or adopt different component arrangements.

The processor 301 serves as the control center of the earphone 300, connecting various parts of the earphone 300 through various interfaces and circuits. By running or loading software programs and/or modules stored in the memory 302 and accessing data stored in the memory 302, the processor 301 performs various functions of the earphone 300 and processes data. The processor 301 may be a CPU, a network processor (NP), or the like, and is capable of implementing or executing the methods, steps, and logic diagrams disclosed in the embodiments of the present application.

In the embodiment of the present application, the processor 301 of the earphone 300 may load the instructions corresponding to the processes of one or more application programs into the memory 302, and execute the application programs stored in the memory 302, thereby implementing various functions, such as:
acquiring a detection request for the wearing state of the earphone.
performing audio collection through a feedback microphone of the earphone to obtain a feedback audio signal.
determining a frequency of an audio, and based on the frequency, determining a target frequency band in the feedback audio signal in which a frequency range meets a preset condition.
determining a power spectrum of the feedback audio signal.
based on the power spectrum, determining an energy magnitude indicator value of the feedback audio signal within a range of the target frequency band.

If the energy magnitude indicator value is not lower than a preset minimum energy threshold corresponding to the in-ear state, the wearing state of the earphone is determined to be the in-ear state. Furthermore, the various functions implemented by executing the application programs stored in the memory 302 can be further referenced in the descriptions of the preceding embodiments, which are not repeated here for brevity.

Furthermore, the various functions implemented by executing the application programs stored in the memory 302 can also be referenced in the descriptions of the foregoing embodiments and will not be repeated here.

The specific implementations of the above operations can be referred to in the preceding embodiments and will not be repeated here.

Optionally, as shown in FIG. 3, the earphone 300 further includes a radio frequency circuit 303, an audio circuit 304, an input unit 305, and a power supply 306. The processor 301 is electrically connected to the radio frequency circuit 303, the audio circuit 304, the input unit 305, and the power supply 306, respectively. It should be understood by those skilled in the art that the earphone structure shown in FIG. 3 does not limit the earphone and may include more or fewer components than illustrated, or may combine certain components, or adopt different component arrangements.

The radio frequency circuit 303 may be used for transmitting and receiving radio frequency signals to establish wireless communication with network devices or other earphones, such as terminals, and to transmit and receive signals (such as audio signals) between the earphone and network devices or other earphones, thereby enabling audio playback.

The audio circuit 304 may be used for audio signal playback and collection through a speaker and a microphone. The audio circuit 304 can convert received audio data into electrical signals and transmit them to the speaker, which then converts the signals into sound for output. On the other hand, the microphone converts collected sound signals into electrical signals, which are received by the audio circuit 304 and converted into audio data. The audio data is then processed by the processor 301 and either transmitted via the radio frequency circuit 303 to another earphone, for example, or output to the memory 302 for further processing.

The input unit 305 may be used to receive input control information (such as volume adjustment, track switching, playback speed fast-forward/rewind, etc.). Optionally, the input unit may include mechanical buttons.

The power supply 306 is used to provide power to the various components of the earphone 300. Optionally, the power supply 306 may be logically connected to the processor 301 through a power management system, thereby enabling functions such as charging management, discharging management, and power consumption control through the power management system. The power supply 306 may also include one or more components such as a direct current or alternating current power source, a rechargeable system, a power fault detection circuit, a power converter or inverter, a power status indicator, and the like.

Although not shown in FIG. 3, the earphone 300 may also include sensors (such as optical sensors and capacitive sensors), a Wi-Fi module, a Bluetooth module, and the like, which are not described in detail herein.

In the above embodiments, each embodiment focuses on different aspects. Parts that are not described in detail in one embodiment may be referenced in the relevant descriptions of other embodiments.

It will be understood by those of ordinary skill in the art that all or part of the steps in the above-mentioned methods of the embodiments can be implemented by instructions, or by controlling the relevant hardware through instructions. These instructions may be stored in a computer-readable storage medium and loaded and executed by a processor.

To this end, an embodiment of the present application provides a computer-readable storage medium, on which a plurality of computer programs are stored. These computer programs can be loaded by a processor to execute any of the earphone wearing state detection methods provided in the embodiments of the present application. For example, the computer program may execute the following steps of an earphone wearing state detection method:

Acquire a detection request for a wearing state of an earphone.
Perform audio collection through a feedback microphone of the earphone to obtain a feedback audio signal.

Determine a frequency of an audio and based on the frequency, determining a target frequency band in the feedback audio signal in which a frequency range meets a preset condition.

Determine a power spectrum of the feedback audio signal.

Based on a power spectrum, determine an energy magnitude indicator value of the feedback audio signal within a range of the target frequency band.

If the energy magnitude indicator value is not lower than a preset minimum energy threshold corresponding to an in-ear state, determine that the wearing state of the earphone is the in-ear state.

Furthermore, the detailed steps of the above method can be referenced in the descriptions of the foregoing embodiments and will not be repeated here.

The specific implementations of the above operations can also be referred to in the preceding embodiments and will not be repeated here.

The computer-readable storage medium may include: Read-Only Memory (ROM), Random Access Memory (RAM), magnetic disks, optical disks, and the like.

Since the computer programs stored in the computer-readable storage medium can execute any of the earphone wearing state detection methods provided in the embodiments of the present application, they can achieve the beneficial effects of such methods as described in the fore going embodiments, which will not be repeated here for brevity.

According to one aspect of the present application, a computer program product or computer program is also provided, which includes computer instructions stored on a computer-readable storage medium. The processor of the earphone reads the computer instructions from the computer-readable storage medium and executes them, enabling the earphone to perform the methods provided in the various optional implementations described in the above embodiments.

In the above embodiments of the earphone wearing state detection apparatus, computer-readable storage medium, earphone, and computer program product, each embodiment focuses on different aspects. Parts that are not described in detail in one embodiment can be referred to in the relevant descriptions of other embodiments. Those skilled in the art will clearly understand that, for the sake of clarity and brevity, the specific working processes and potential benefits of the earphone wearing state detection apparatus, computer-readable storage medium, computer program product, earphone, and their corresponding components, as described above, can be referenced in the descriptions of the earphone wearing state detection method in the foregoing embodiments, and are therefore not repeated here.

The above provides a detailed description of an earphone wearing state detection method, apparatus, earphone, computer-readable storage medium, and computer program product according to the embodiments of the present application. Specific examples have been used to illustrate the principles and implementations of the present application. The descriptions of the above embodiments are intended to help understand the method and core concepts of the present application. At the same time, for those skilled in the art, modifications in specific implementations and application scopes may be made based on the ideas of the present application. In summary, the content of this specification should not be interpreted as limiting the present application.

1. An earphone wearing state detection method, comprising:
acquiring a detection request for a wearing state of an earphone;
performing audio collection through a feedback microphone of the earphone to obtain a feedback audio signal;
determining a frequency of an audio and based on the frequency, determining a target frequency band in the feedback audio signal in which a frequency range meets a preset condition;
determining a power spectrum of the feedback audio signal;
based on a power spectrum, determining an energy magnitude indicator value of the feedback audio signal within a range of the target frequency band;
if the energy magnitude indicator value is not lower than a preset minimum energy threshold corresponding to an in-ear state, determining that the wearing state of the earphone is the in-ear state.

2. The earphone wearing state detection method according to claim 1, wherein when performing audio collection through the feedback microphone of the earphone, the audio is further collected through a feedforward microphone of the earphone to obtain a feedforward audio signal;
the method further comprises:
performing sound pressure level analysis on the feedforward audio signal and the feedback audio signal to determine a first sound pressure level of the feedforward audio signal and a second sound pressure level of the feedback audio signal;
determining a sound pressure level difference between the first sound pressure level and the second sound pressure level;
if the sound pressure level difference is not less than a maximum sound pressure level difference threshold, determining that the wearing state of the earphone is the in-ear state; otherwise, determining that the wearing state of the earphone is an out-of-ear state.

3. The earphone wearing state detection method according to claim 2, wherein performing sound pressure level analysis on the feedforward audio signal and the feedback audio signal comprises:
if the energy magnitude indicator value is lower than the preset minimum energy threshold, performing sound pressure level analysis on the feedforward audio signal and the feedback audio signal.

4. The earphone wearing state detection method according to claim 2, wherein determining the first sound pressure level of the feedforward audio signal and the second sound pressure level of the feedback audio signal comprises:
performing spectrum analysis on the feedforward audio signal and the feedback audio signal to determine a first spectrum of the feedforward audio signal and a second spectrum of the feedback audio signal;
correcting a spectrum parameter of the first spectrum and a spectrum parameter of the second spectrum;
determining the first sound pressure level of the feedforward audio signal and the second sound pressure level of the feedback audio signal based on a corrected first spectrum and a corrected second spectrum.

5. The earphone wearing state detection method according to claim 1, wherein determining the target frequency band in the feedback audio signal in which the frequency range meets the preset condition based on the frequency comprises:
acquiring a frequency band length of the target frequency band to be determined;
determining, based on the frequency and the frequency band length, the target frequency band that contains the frequency and has a length equal to the frequency band length.

6. The earphone wearing state detection method according to claim 1, wherein determining the energy magnitude indicator value of the feedback audio signal within the range of the target frequency band based on the power spectrum comprises:
determining a power of the feedback audio signal within the range of the target frequency band based on the power spectrum;
performing a root mean square calculation on the power within the range of the target frequency band to determine the energy magnitude indicator value.

7. The earphone wearing state detection method according to claim 1, wherein acquiring the detection request for the wearing state of the earphone comprises:
periodically generating the detection request for the wearing state of the earphone; or
generating the detection request for the wearing state of the earphone when a sensor of the earphone detects that the wearing state of the earphone has switched to the in-ear state.

8. An earphone wearing state detection apparatus, comprising:
a detection request acquisitor configured to acquire a detection request for a wearing state of an earphone;
a feedback audio signal determiner configured to perform audio collection through a feedback microphone of the earphone to obtain a feedback audio signal;
a target frequency band determiner configured to determine a frequency of an audio and based on the frequency, determine a target frequency band in the feedback audio signal in which the frequency range meets a preset condition;
a power spectrum determiner configured to determine a power spectrum of the feedback audio signal;
an energy magnitude indicator value determiner configured to determine, based on the power spectrum, an energy magnitude indicator value of the feedback audio signal within the range of the target frequency band;
a wearing state determiner configured to determine that the wearing state of the earphone is an in-ear state if the energy magnitude indicator value is not lower than a preset minimum energy threshold corresponding to the in-ear state.

9. An earphone, comprising:
a processor and a memory, wherein the memory stores a plurality of instructions;
wherein the processor is configured to load the instructions from the memory to execute an earphone wearing state detection method comprising:
acquiring a detection request for a wearing state of an earphone;
performing audio collection through a feedback microphone of the earphone to obtain a feedback audio signal;
determining a frequency of an audio and based on the frequency, determining a target frequency band in the feedback audio signal in which a frequency range meets a preset condition;
determining a power spectrum of the feedback audio signal;
based on a power spectrum, determining an energy magnitude indicator value of the feedback audio signal within a range of the target frequency band;
if the energy magnitude indicator value is not lower than a preset minimum energy threshold corresponding to an in-ear state, determining that the wearing state of the earphone is the in-ear state.

10. (canceled)

11. The earphone wearing state detection apparatus according to claim 8, wherein when the feedback audio signal determiner performs audio collection through the feedback microphone of the earphone, the feedback audio signal determiner further collects the audio through a feedforward microphone of the earphone to obtain a feedforward audio signal.

12. The earphone wearing state detection apparatus according to claim 8, wherein if the energy magnitude indicator value is lower than the preset minimum energy threshold, the earphone wearing state detection apparatus performs sound pressure level analysis on the feedforward audio signal and the feedback audio signal.

13. The earphone wearing state detection apparatus according to claim 8, wherein the target frequency band determiner is configured to:
acquire a frequency band length of the target frequency band to be determined; and
determine a target frequency band that contains the frequency and has a length equal to the frequency band length, based on the frequency and the frequency band length.

14. The earphone wearing state detection apparatus according to claim 8, wherein the energy magnitude indicator value determiner is configured to:
determine a power of the feedback audio signal within a range of the target frequency band based on the power spectrum;
perform a root mean square calculation on the power within the target frequency band to determine the energy magnitude indicator value.

15. The earphone wearing state detection apparatus according to claim 8, wherein the detection request acquisitor is configured to:
periodically generate a detection request for the wearing state of the earphone; or
generate a detection request for the wearing state of the earphone when a sensor of the earphone detects that the wearing state has switched to the in-ear state.

16. The earphone according to claim 9, wherein when the processor performs audio collection through the feedback microphone of the earphone, the processor further collects the audio through a feedforward microphone of the earphone to obtain a feedforward audio signal.

17. The earphone according to claim 16, wherein the processor is further configured to:
perform sound pressure level analysis on the feedforward audio signal and the feedback audio signal to determine a first sound pressure level of the feedforward audio signal and a second sound pressure level of the feedback audio signal;
determine a sound pressure level difference between the first sound pressure level and the second sound pressure level;
if the sound pressure level difference is not less than a maximum sound pressure level difference threshold, determine that the wearing state of the earphone is the in-ear state;
otherwise, determine that the wearing state of the earphone is an out-of-ear state.

18. The earphone according to claim 16, wherein if the energy magnitude indicator value is lower than the preset minimum energy threshold, the processor performs sound pressure level analysis on the feedforward audio signal and the feedback audio signal.

19. The earphone according to claim 16, wherein the processor is further configured to:
perform spectrum analysis on the feedforward audio signal and the feedback audio signal to determine a first spectrum of the feedforward audio signal and a second spectrum of the feedback audio signal;
correct a spectrum parameter of the first spectrum and a spectrum parameter of the second spectrum;
determine the first sound pressure level of the feedforward audio signal and the second sound pressure level of the feedback audio signal based on a corrected first spectrum and a corrected second spectrum.

20. The earphone according to claim 9, wherein the processor is further configured to:
acquire a frequency band length of the target frequency band to be determined;
determine, based on the frequency and the frequency band length, the target frequency band that contains the frequency and has a length equal to the frequency band length.

21. The earphone according to claim 9, wherein the processor is further configured to:
determine a power of the feedback audio signal within the range of the target frequency band based on the power spectrum;
perform a root mean square calculation on the power within the range of the target frequency band to determine the energy magnitude indicator value.
